(19) United States
(12) Patent Application Publication
(10) Pub. No.: US 2019/0210054 A1
(43) Pub. Date: Jul. 11, 2019

(54) DIFFUSER ASSEMBLY

(71) Applicant: CHENG-YANG CHAN, TAICHUNG CITY (TW)

(72) Inventor: CHENG-YANG CHAN, TAICHUNG CITY (TW)

(21) Appl. No.: 15/864,149

(22) Filed: Jan. 8, 2018

(51) Int. Cl. B05B 17/06; B05B 7/00

(52) U.S. Cl. CPC B05B 17/0607; B05B 7/0081

(57) ABSTRACT

A diffuser assembly includes a case having multiple inlets defined through the bottom thereof. A reception space and a first room are respectively defined in the case. The first room communicates with the inlets and the reception space. A cup is received in the reception space of the case and includes a second room. An ultrasonic oscillator is connected to the cup and located corresponding to the second room. A fan is located in the first room so as to suck outside air into the first room, the slot and the second room via the inlets. The cup and the ultrasonic oscillator are able to be separated from the case for maintenance.

### BACKGROUND OF THE INVENTION

### 1. Fields of the Invention

The present invention relates to a diffuser assembly, and more particularly, to a diffuser assembly that the cup and ultrasonic oscillator can be easily replaced.

### 2. Descriptions of Related Art

The conventional aromatherapy essential oil diffusers generally comprise a cup in which the mixture of water and oil is received, and an ultrasonic oscillator is installed to the cup so as to generate small particles of the mixture to achieve the purposes of aromatherapy.

However, the oil will attach onto the ultrasonic oscillator to affect the normal operation of the ultrasonic oscillator. The consumers cannot clean the ultrasonic oscillator easily, and most of the consumers choose to get another new diffuser. For some users, they will send the diffusers to be maintained, a lot of waiting time and expense are needed.

The present invention intends to provide a diffuser assembly that the cup and ultrasonic oscillator can be easily replaced.

### SUMMARY OF THE INVENTION

The present invention relates to a diffuser assembly and comprises a case having multiple inlets defined through the bottom thereof. A reception space 22 is defined in the case and communicates with the open top of the case. A first room is defined in the case and communicates with the inlets and the reception space. A cup is received in the reception space of the case and has a second room defined therein. A slot is defined through the wall of the cup and communicates with the first room and the second room. An ultrasonic oscillator is connected to the cup and located corresponding to the second room. A fan is located in the first room and sucks outside air into the first room, the slot and the second room via the inlets.

The present invention also provides an inner unit of a diffuser assembly, and comprises a cup having a second room defined therein. An ultrasonic oscillator is connected to the cup and located corresponding to the second room.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the diffuser assembly of the present invention;

FIG. 2 is an exploded view of the diffuser assembly of the present invention;

FIG. 3 is an exploded view of the cup and the ultrasonic oscillator of the diffuser assembly of the present invention;

FIG. 4 is a cross sectional view, taken along line IV-IV in FIG. 1;

FIG. 5 is a cross sectional view, taken along line V-V in FIG. 1, and

FIG. 6 shows the operational status of the diffuser assembly of the present invention.

### DETAILED DESCRIPTION OF THE PREFERRED EMBODIMENT

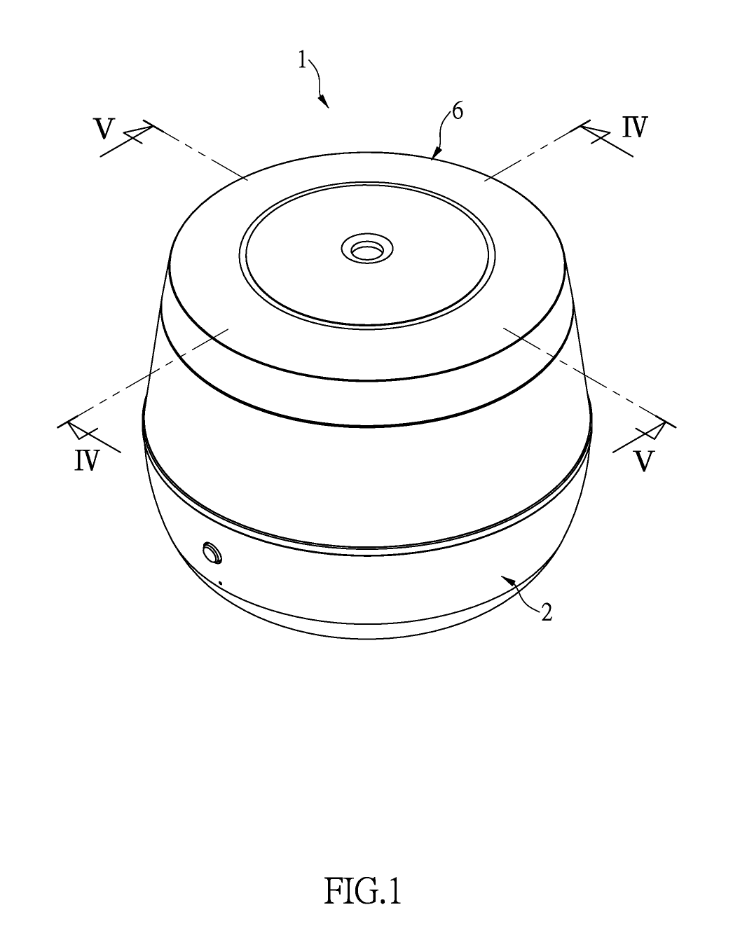

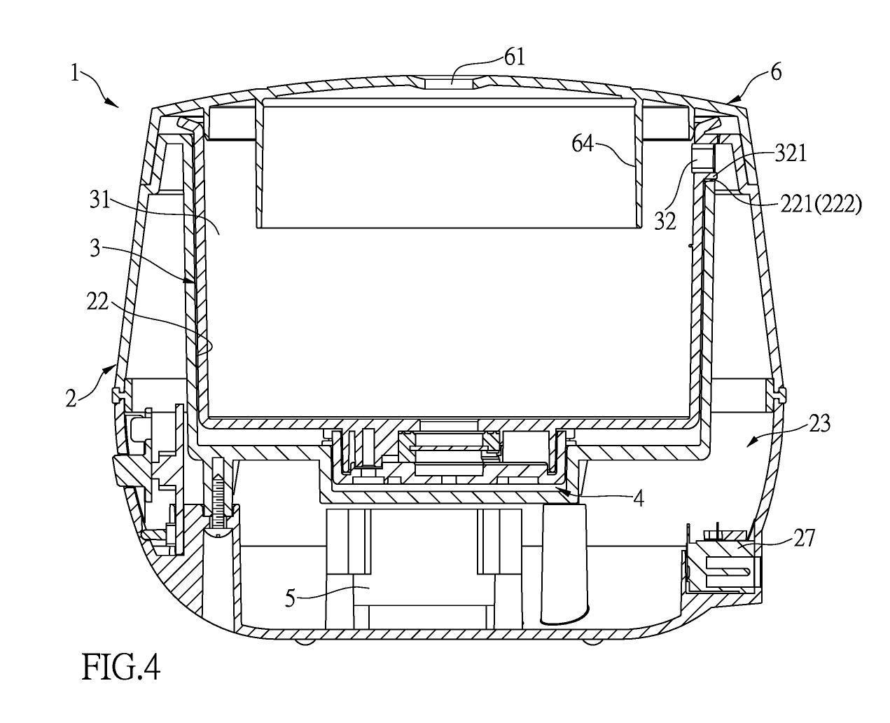

Referring to FIGS. 1 to 6, the diffuser assembly 1 of the present invention comprises a case 2 having multiple inlets 21 defined through the bottom thereof. A reception space 22 is defined in the case 2 and communicates with the open top of the case 2. A first room 23 is defined in the case 2 and communicates with the inlets 21 and the reception space 22. A cup 3 is received in the reception space 22 of the case 2 and includes a second room 31 defined therein. A slot 32 is defined through the wall of the cup 3 and communicates with the first room 23 and the second room 31. An ultrasonic oscillator 4 is connected to the cup 3 and located corresponding to the second room 31. A fan 5 is located in the first room 23 and so as to suck outside air into the first room 23, the slot 32 and the second room 31 via the inlets 21. The fan 5 is located to close to the inlets 21.

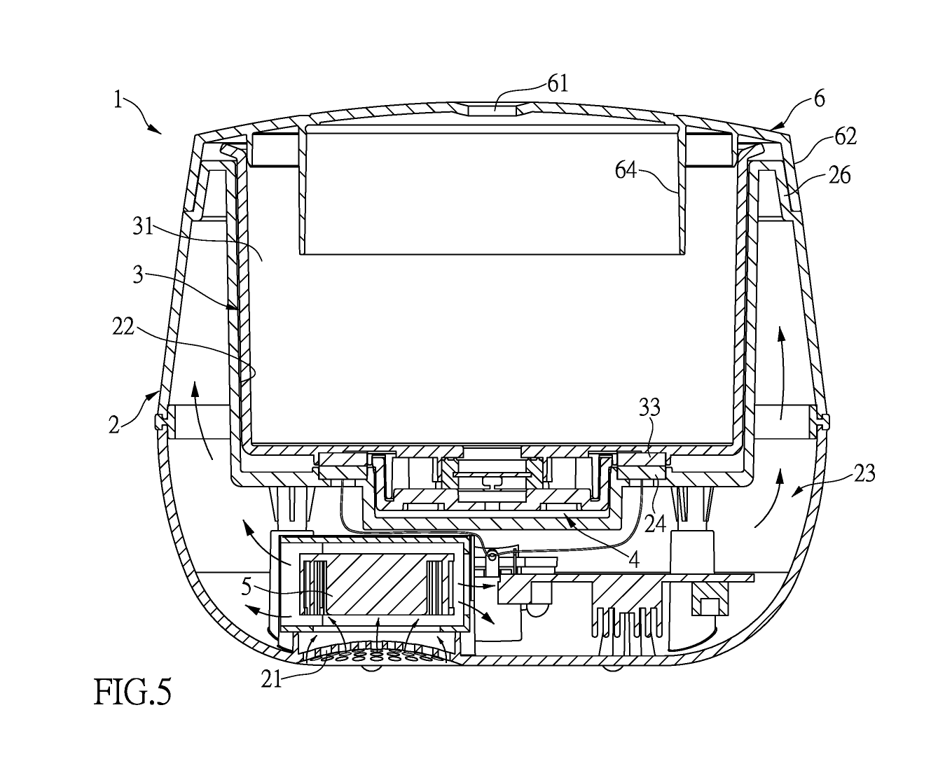

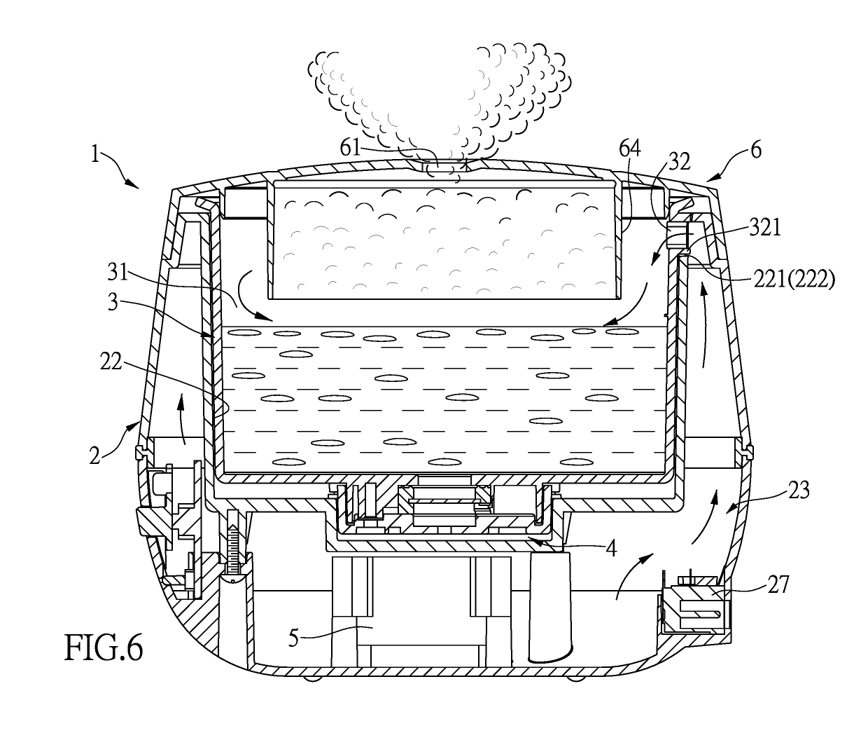

As shown in FIGS. 5 and 6, oil or a mixture of oil and water is added into the second room 31 of the cup 3. The ultrasonic oscillator 4 oscillates the mixture in the second room 31 to create small particles of the mixture. The fan 5 sucks outside air into the first room 23, the slot 32 and the second room 31 via the inlets 21 so as to spray the small particles of the mixture into the interior of rooms.

The installation of the ultrasonic oscillator 4 to the cup 3, and the installation of the cup 3 to the reception space 22 of the case 2 allow the users or the sellers to separate the ultrasonic oscillator 4 and the cup 3 from the case 2 so as to easily clean the ultrasonic oscillator 4 and the cup 3.

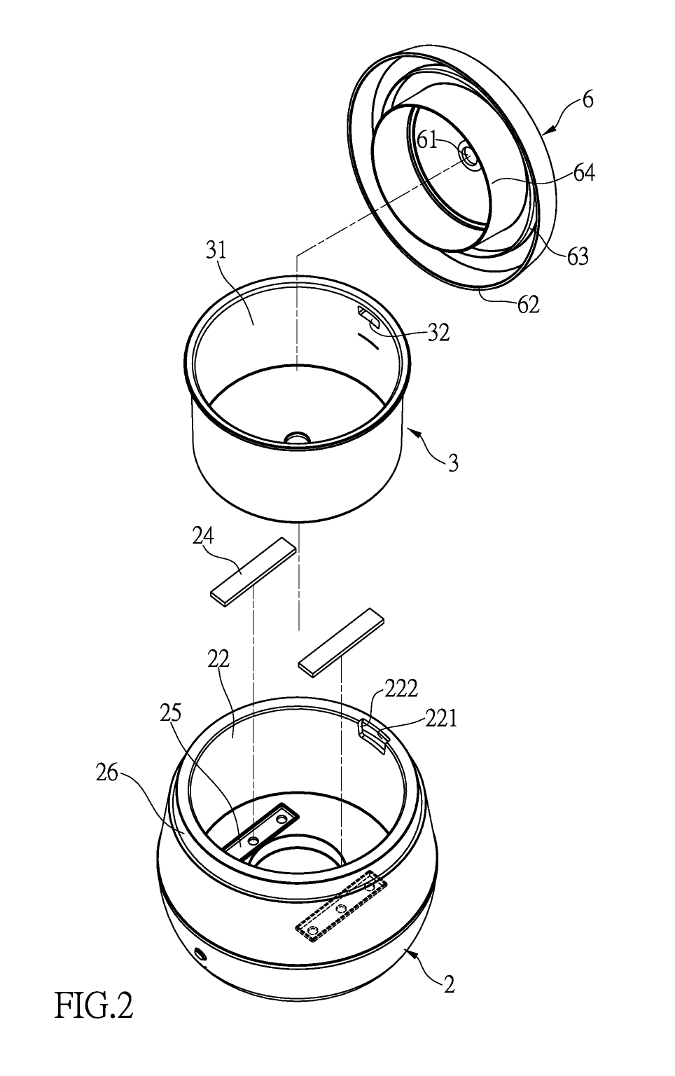

As shown in FIGS. 2, 3 and 5, multiple first conductive portions 24 are located in the reception space 22, and the cup 3 has multiple second conductive portions 33 which are in contact with the first conductive portions 24. The second conductive portions 33 are electrically connected to the ultrasonic oscillator 4. The first and second conductive portions 24, 33 are electric-conductive material blended into the waved fabric so that when they are in contact with each other, the electric power can be transferred to the ultrasonic oscillator 4.

The cup 3 includes an installation hole 34 defined through the bottom thereof, and the installation hole 34 communicates with the second room 31. The ultrasonic oscillator 4 is installed to the installation hole 34. Besides, the case 2 includes multiple first recesses 25 defined in the inner bottom thereof. The first conductive portions 24 are received in the first recesses 25. The cup 3 includes multiple second recesses 35 defined in the underside thereof, and the second recesses 35 are located next the installation hole 34. The second conductive portions 33 are received in the second recesses 35.

A cover 6 is mounted to the case 2 and contacts a shoulder 26 protruding from the outside of the case 2 so as to cover the second room 31 of the cup 3. The cover 6 includes an outlet 61 which communicates with the second room 31 of the cup 3. The cover 6 further includes an outer skirt 62 and an inner skirt 63 respectively extending from the underside thereof. The outer skirt 62 is in contact with the outside of the shoulder 26 and the inner skirt 63 is in contact with the inside of the second room 31 of the cup 3. The cover 6 further includes a tubular portion 64 extending from the underside thereof, and the tubular portion 64 extends into the second room 31 of the cup 3. A gap is formed between the tubular portion 64 and the second room 31 of the cup 3. The tubular portion 64 restrict the small particles of the mixture from spreading in the first room 23. Specifically, the distal end of the tubular portion 64 is lower than the slot 32.

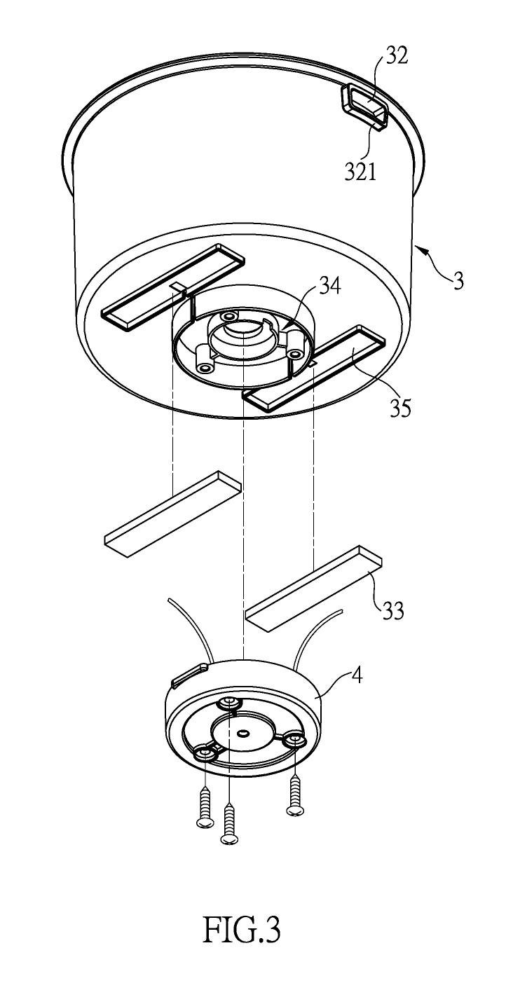

The case 2 includes an electric power source 27 which is electrically connected with the first conductive portions 24 and the fan 5. The case 2 includes a notch 222 defined in the inside of the wall thereof. A hole 221 is defined through the inner end of the notch 222 and communicates with the reception space 22 as shown in FIG. 2. The cup 3 includes a positioning portion 321 protruding from the outside thereof. The slot 32 is located at the center of the positioning portion 321 as shown in FIG. 3. The positioning portion 321 is received in the notch 222, and the hole 221 communicates with the slot 32. The engagement between the positioning portion 321 and the notch 222 allows the cup 3 to be easily installed to the case 2. The communication between the hole 221 and the slot 32 makes the first room 23 communicate with the second room 31.

The inner unit of the diffuser assembly is simplified to be the cup 3 and the ultrasonic oscillator 4. The cup 3 has the second room 31 and the ultrasonic oscillator 4 is connected to the cup 3 and located corresponding to the second room 31.

While we have shown and described the embodiment in accordance with the present invention, it should be clear to those skilled in the art that further embodiments may be made without departing from the scope of the present invention.

What is claimed is:

1. A diffuser assembly comprising:
a case having multiple inlets defined through a bottom thereof, a reception space defined in the case and communicating with an open top of the case, a first room defined in the case and communicating with the inlets and the reception space;
a cup received in the reception space of the case and having a second room defined therein, a slot defined through a wall of the cup and communicating with the first room and the second room, an ultrasonic oscillator connected to the cup and located corresponding to the second room, and
a fan located in the first room and adapted to suck outside air into the first room, the slot and the second room via the inlets.

2. The diffuser assembly as claimed in claim 1, wherein multiple first conductive portions are located in the reception space, the cup has multiple second conductive portions which are in contact with the first conductive portions, the second conductive portions are electrically connected to the ultrasonic oscillator.

3. The diffuser assembly as claimed in claim 2, wherein the cup includes an installation hole defined through a bottom thereof, the installation hole communicates with the second room, the ultrasonic oscillator is installed to the installation hole.

4. The diffuser assembly as claimed in claim 3, wherein the case includes multiple first recesses defined in an inner bottom thereof, the first conductive portions are received in the first recesses, the cup includes multiple second recesses defined in an underside thereof, the second recesses are located next the installation hole, the second conductive portions are received in the second recesses.

5. The diffuser assembly as claimed in claim 1, wherein a cover is mounted to the case and contacts a shoulder protruding from an outside of the case so as to cover the second room of the cup, the cover includes an outlet which communicates with the second room of the cup.

6. The diffuser assembly as claimed in claim 5, wherein the cover includes an outer skirt extending from an underside thereof, the outer skirt is in contact with an outside of the shoulder.

7. The diffuser assembly as claimed in claim 6, wherein the cover includes an inner skirt extending from the underside thereof, the inner skirt is in contact with an inside of the second room of the cup.

8. The diffuser assembly as claimed in claim 7, wherein the cover includes a tubular portion extending from the underside thereof, the tubular portion extends into the second room of the cup, a gap is formed between the tubular portion and the second room of the cup.

9. The diffuser assembly as claimed in claim 1, wherein the case includes an electric power source which is electrically connected with the first conductive portions and the fan.

10. The diffuser assembly as claimed in claim 1, wherein the case includes a notch defined in an inside of a wall thereof, a hole is defined through an inner end of the notch and communicates with the reception space, the cup includes a positioning portion protruding from an outside thereof, the slot is located at a center of the positioning portion, the positioning portion is received in the notch, the hole communicates with the slot.

11. An inner unit of a diffuser assembly, comprising:
a cup having a second room defined therein, and
an ultrasonic oscillator connected to the cup and located corresponding to the second room.

12. The inner unit of a diffuser assembly as claimed in claim 11, wherein the cup has multiple second conductive portions which are electrically connected to the ultrasonic oscillator.

13. The inner unit of a diffuser assembly as claimed in claim 12, wherein the cup includes multiple second recesses defined in an underside thereof, the second conductive portions are received in the second recesses.

14. The inner unit of a diffuser assembly as claimed in claim 11, wherein the cup includes an installation hole defined through a bottom thereof, the installation hole communicates with the second room, the ultrasonic oscillator is installed to the installation hole.

15. The inner unit of a diffuser assembly as claimed in claim 14, wherein the cup includes a positioning portion protruding from an outside thereof, the slot is located at a center of the positioning portion.
